(19) United States
(12) Patent Application Publication
(10) Pub. No.: US 2007/0064217 A1
(43) Pub. Date: Mar. 22, 2007

(54) THEODOLITE WITH A LASER INDICATOR

(76) Inventor: Nen-Tsua Li, Taichung (TW)

Correspondence Address: BIRCH STEWART KOLASCH & BIRCH, PO BOX 747, FALLS CHURCH, VA, 22040-0747, US

(21) Appl. No.: 11/228,384

(22) Filed: Sep. 19, 2005

(51) Int. Cl. G01C 3/08; G02B 23/00

(52) U.S. Cl. 356/5.01; 359/431

(57) ABSTRACT

A theodolite has a body, a telescope, a laser indicator, pushbuttons and a display. The laser indicator is mounted on the telescope and has a casing, a transmission device, a prism, a laser generator and a base. The transmission device is mounted in the casing. The prism is mounted on the transmission device. The laser generator is mounted in the casing and generates a laser beam refracted by the prism to aim at a target when turned on. The base is mounted between the laser indicator and the telescope and has a stationary bracket and a movable bracket. The stationary bracket is mounted to the telescope. The casing of the laser indicator is mounted on the movable bracket, which is itself mounted rotatably and slidably on the stationary bracket. The laser indicator precisely aims at a target so virtual axes can be accurately defined by the theodolite.

### BACKGROUND OF THE INVENTION

1. Field of the Invention

The present invention relates to a theodolite, and more particularly to a theodolite that has a laser indicator generating a laser beam to accurately indicate a predicted position on the ground so a datum marker can be put precisely on a position indicated by the laser beam without any inaccuracy.

2. Description of Related Art

Theodolites are surveying instruments used to survey topography or architectural structures.

With reference to FIG. 8, a conventional theodolite (60) comprises a base (61), a body, multiple pushbuttons (63), a display (64) and a telescope (62). The base (61) is mounted to a tripod. The body is mounted rotatably on the base (61). The pushbuttons (63) are mounted on the body and provide functions such as turning the unit on/off, setting of a datum, and so forth. The display (64) is mounted on the body and displays information. The telescope (62) is mounted on the body and allows a surveyor to aim at a target as a first datum or a second datum at a specific angle from the first datum.

With reference to FIG. 9, an example of a survey with a conventional theodolite (60) is described as follows.

A conventional theodolite (60) is set at a point (A). A first surveyor, by naked eye through the telescope (62), aims at an object, a point (C), to set as a datum preset. The first surveyor presses one of the pushbuttons (63) when he makes sure that the datum is exactly aimed so a virtual X-axis (B) is defined in the theodolite (60) and is shown in the display (64). Next, the first surveyor rotates the body a specific angle, such as 90 degrees, aims at a second datum (E) and defines a virtual Y-axis in the theodolite (60). At a signal from the first surveyor, a second surveyor marks the second datum with a marker, or a cord set between the point (A) and the second datum (E). Next, points (F, G) along the virtual Y-axis as the third and fourth data are set with the theodolite (60) in order.

However, a conventional theodolite (60) has several disadvantages, which are explained as follows:

1. The X-axis defined only by the naked eye through the telescope (62) may not correspond precisely to the real position of the first datum at the point (C), so the Y-axis according to the incorrect X-axis would also be wrong.

2. The operation of a conventional theodolite (60) requires at least two surveyors and is inconvenient and ineffective.

3. The second surveyor, following the first surveyor's signal, may set a marker in an incorrect location. The Y-axis set would not conform to the virtual X-axis set in the theodolite (60).

To overcome the shortcomings, the present invention provides a theodolite with a laser indicator to mitigate or obviate the aforementioned problems.

### SUMMARY OF THE INVENTION

The main objective of the invention is to provide a theodolite that has a laser indicator generating a laser beam to accurately indicate a predicted position on the ground so a datum marker can be put precisely on a position indicated by the laser beam without any inaccuracy.

A theodolite in accordance with the present invention comprises a body, a telescope, a laser indicator, pushbuttons and a display.

The laser indicator is mounted on the telescope and has a casing, a transmission device, a prism, a laser generator and a base. The transmission device is mounted in the casing. The prism is mounted on the transmission device. The laser generator is mounted in the casing and generates a laser beam refracted by the prism to aim at a target when turned on. The base is mounted between the laser indicator and the telescope, and has a stationary bracket and a movable bracket. The stationary bracket is mounted on the telescope. The movable bracket is mounted rotatably and slidably on the stationary bracket and is attached to the casing.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a theodolite with a laser indicator in accordance with the present invention;

FIG. 2 is a perspective view in partial section of the laser indicator of the theodolite in FIG. 1;

FIG. 3 is an exploded perspective view of the laser indicator of the theodolite in FIG. 2;

FIG. 4 is an operational front view of the laser indicator of the theodolite in FIG. 2 inclined by adjusting the bolts;

FIG. 5 is a top view in partial section of the base of the laser indicator of the theodolite in FIG. 2 with the indicator removed;

FIG. 6 is an operational top view in partial section of the base of the laser indicator of the theodolite in FIG. 5 with the movable bracket moved relative to the stationary bracket;

FIG. 7 is an operational top view in partial section of the base of the laser indicator of the theodolite in FIG. 5 with the movable bracket rotated relative to the stationary bracket;

FIG. 8 is a perspective view of a conventional theodolite in accordance with the prior art; and

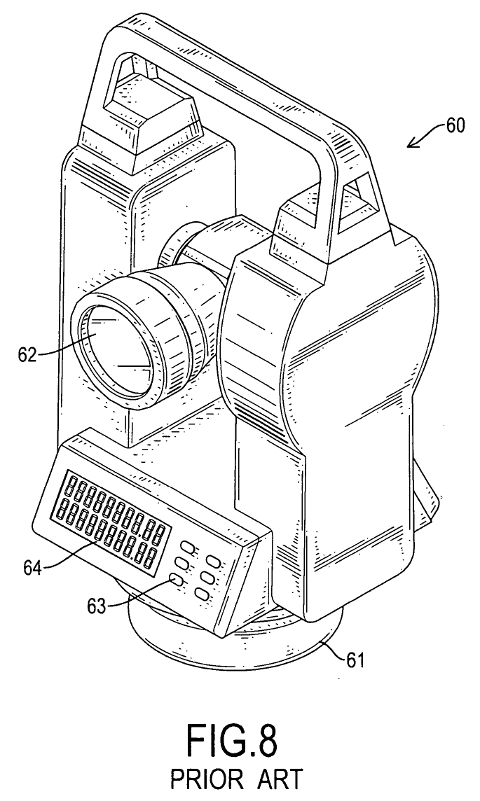

FIG. 9 is an operational top view of the conventional theodolite in FIG. 8 set at the point (A) to define an X-axis (B) and a Y-axis (D).

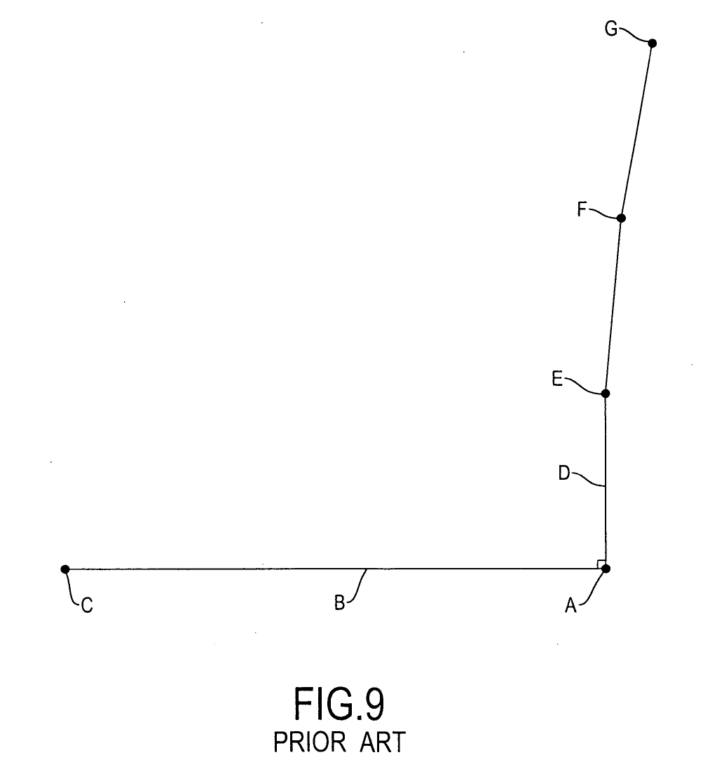

### DETAILED DESCRIPTION OF PREFERRED EMBODIMENT

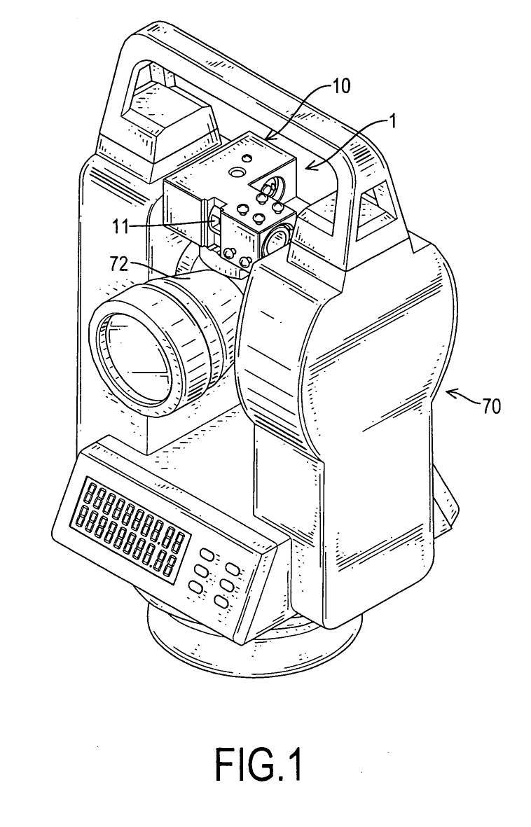

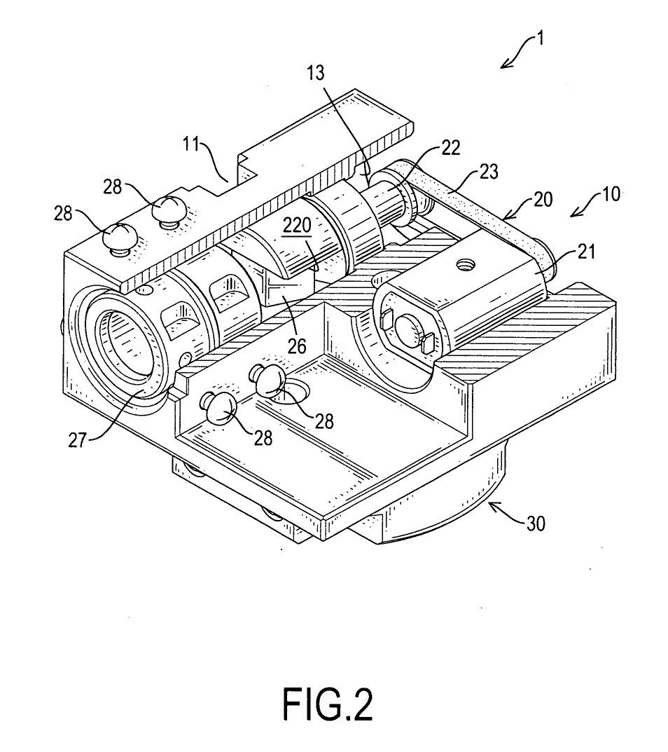

With reference to FIGS. 1 and 2, a theodolite in accordance with the present invention comprises a body (70), a telescope (72), a laser indicator (1), a base (30), multiple pushbuttons and a display.

The telescope (72) is mounted on the body (70) and has a top.

With reference to FIG. 2, the laser indicator (1) is mounted on the top of the telescope (72) and has a casing (10), a transmission device (20), a prism (26) and a laser generator (27).

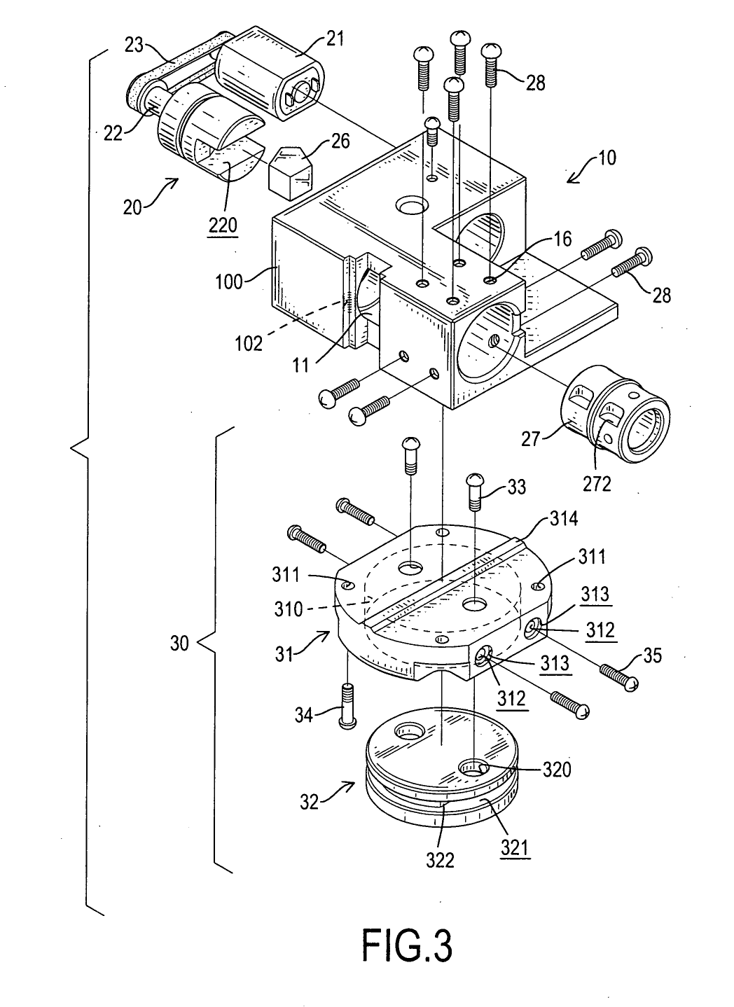

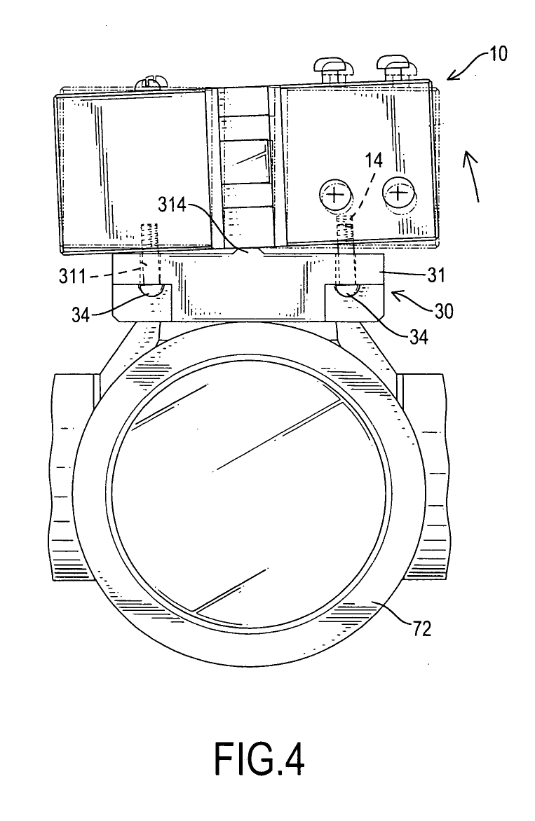

With further reference to FIGS. 3 and 4, the casing (10) has a front, a bottom, a cavity (13), a window (11), four casing-adjusting holes (14) and multiple generator-adjusting holes (16). The cavity (13) is defined in the casing (10). The window (11) is defined through the front of the casing and communicates with the cavity (13). The casing-adjusting holes (14) and the generator-adjusting holes (16) are threaded. The casing-adjusting holes (14) are defined in the bottom of the casing (10). The generator-adjusting holes (16) are defined in the casing (10) and communicate with the cavity (13).

The transmission device (20) is mounted in the cavity (30) in the casing (10) and has a motor (21), a prism mount (22) and a belt (23). The motor (21) is mounted in the cavity (13) and has a rotatable shaft. The prism mount (22) is mounted rotatably in the cavity (13) and has a proximal end, a distal end and a recess (220). The recess (220) is defined in the distal end and aligned with the window (11). The belt (23) is mounted around the proximal end of the prism mount (22) and the shaft of the motor (21) on pulleys. The prism mount (22) can then be rotated by the motor (21).

The prism (26) may be a pentagonal prism, and is mounted in the recess (220) in the prism mount (22) and in alignment with the window (11).

The laser generator (27) is mounted in the cavity (13), and may be mounted movably or fixed. The laser generator (27) is aligned with the prism (26), and generates a laser beam to the prism (26) when turned on. The laser beam is refracted by the prism (26) and directed out of the window (11). A surveyor can see the spot of light projected by the laser beam on a target through the telescope (72) without the aid of another person. With the laser beam capable of extending for over 200 meters, the theodolite can precisely align a far datum point. When the theodolite precisely defines a first virtual axis according to the aimed datum, other virtual axes can be correctly defined according to the first virtual axis without any inaccuracy caused by human error. Moreover, an optical sensor can be used as a datum target with which the laser beam is aligned that can emit a sound or radiate a signal when the laser beam is exactly aligned with the optical sensor. Because a surveyor can look through the telescope (72) to make sure whether or not the target has been hit by the laser beam, the operation can be completed by a single surveyor.

The laser generator (26) has an outer surface, multiple notches (272) and multiple generator-adjusting bolts (28). The notches (272) are semi-circular depressions defined in the outer surface. The generator-adjusting bolts (28) are mounted respectively through the generator-adjusting holes (16) in the casing (10) and respectively engage the notches (272) in the laser generator (27). The generator-adjusting bolts (28) can be extended into the cavity (13) to varying depths to adjust the position and orientation of the laser generator (27), and in turn, the direction of the laser beam generated.

The base (30) is mounted on the top of the telescope (72) and is connected to the laser indicator (1). The base (30) has a stationary bracket (32), multiple mounting bolts (33), a movable bracket (31), two pairs of bracket-adjusting bolts (35) and four casing-adjusting bolts (34).

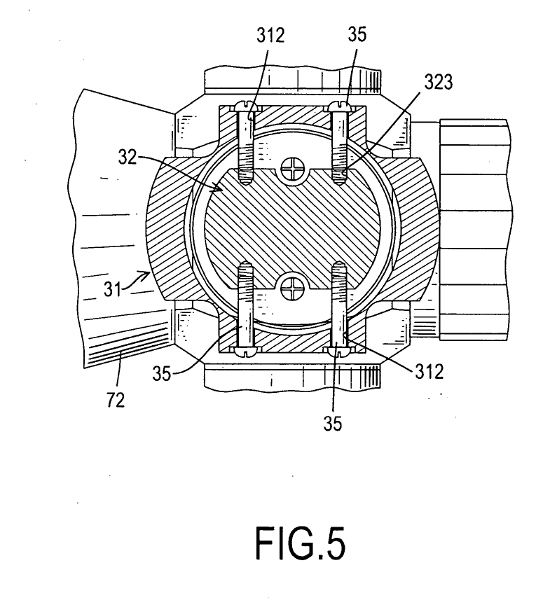

With further reference to FIG. 5, the stationary bracket (32) is mounted on the top of the telescope (72) and has a median segment (322), two opposite recesses (321), multiple mounting holes (320) and two pairs of bracket-adjusting holes (323). The recesses (321) are defined on both sides of the median segment (322) in parallel. The mounting holes (320) are defined vertically through the stationary bracket (32). The two pairs of bracket-adjusting holes (323) are defined respectively in the median segment (322) in the recesses (321).

The mounting bolts (33) extend through the mounting holes (320) in the stationary bracket (32) and screw into the top of the telescope (72) to securely hold the stationary bracket on the telescope (72).

The movable bracket (31) is mounted rotatably and slidably on the stationary bracket (32), and has a bottom, a top, two sides, a bracket recess (310), a pivot ridge (314), four casing-adjusting holes (311) and two pairs of bracket-adjusting holes (312). The bracket recess (310) is defined in the bottom of the movable bracket (31) and rotatably and slidably holds the stationary bracket (32). The pivot ridge (314) is formed on the top of the movable bracket (31) and abuts the bottom of the casing (10) so that the casing (10) is able to pivot slightly on the pivot ridge (314). The casing-adjusting holes (311) are defined vertically through the movable bracket (31) at intervals. The pairs of bracket-adjusting holes (312) are defined respectively in the sides of the movable bracket (31).

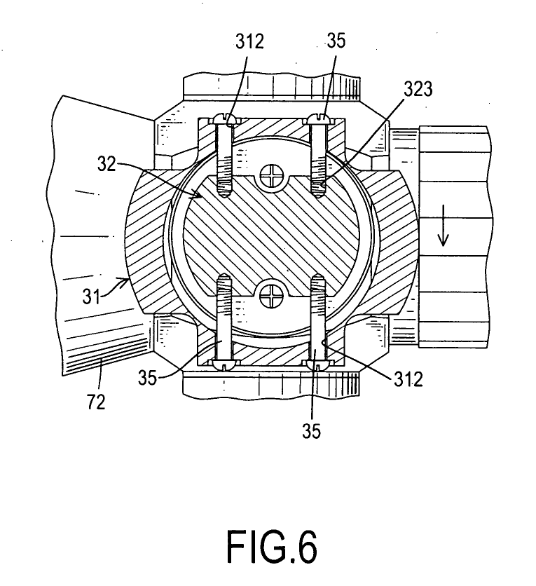

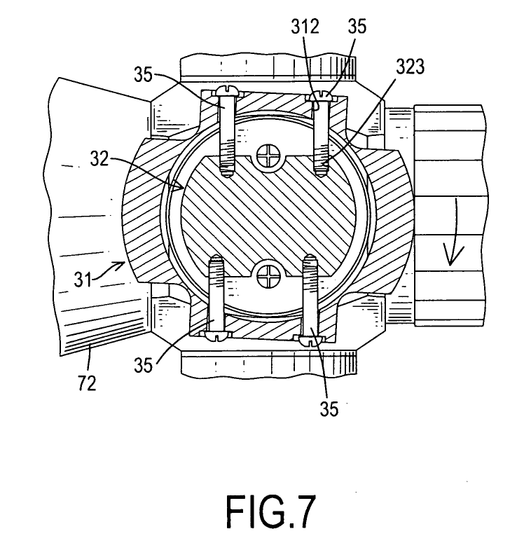

With further reference to FIGS. 6 and 7, the pairs of bracket-adjusting bolts (35) extend through the pairs of the bracket-adjusting holes (312) in the sides of the movable bracket (31) and screw into the pairs of bracket-adjusting holes (312) in the stationary bracket (31). Changing the depths which the pairs of the bracket-adjusting bolts (35) extend into the bracket-adjusting holes (312) causes the movable bracket (32) to rotate or slide transversely on the stationary bracket (31). Accordingly, the rotation and position of the laser beam can be adjusted.

The casing-adjusting bolts (34) extend through the casing-adjusting holes (311) in the movable bracket (31) and screw into the casing-adjusting holes (14) in the bottom of the casing (10). Changing the depths which the casing-adjusting bolts (34) extend into the bottom of the casing (10) causes the casing (10) to pivot on the pivot ridge (314) on the movable bracket (31) and adjusts the angle of the plane on which the casing (10) lies, as shown in FIG. 4.

The pushbuttons and the display are mounted on the body (70) and are connected to the laser indicator so a user can operate the theodolite through the pushbuttons.

The laser indicator (1) precisely aims a laser beam at a target so virtual axes can be accurately defined by the theodolite. Furthermore, the operation of the theodolite needs only one surveyor and is convenient and effective.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A theodolite comprising:
a body;
a telescope mounted on the body and having a top;
a laser indicator mounted on the top of the telescope and having
a casing having
a front;
a bottom;
a cavity defined in the casing;
a window defined through the front of the casing and communicating with the cavity; and
four threaded casing-adjusting holes defined through the casing and communicating with the cavity;
a transmission device mounted in the cavity in the casing and having
a motor mounted in the cavity and having a rotatable shaft;
a prism mount mounted rotatably in the cavity and having a proximal end, a distal end and a recess defined in the distal end and aligned with the window; and
a belt mounted around the proximal end of the prism mount and the shaft of the motor;
a prism mounted in the recess in the prism mount and aligned with the window; and
a laser generator mounted in the cavity, aligned with the prism and generating a laser beam refracted by the prism when turned on;
a base mounted on the top of the telescope, connected to the laser indicator and having
a stationary bracket mounted on the top of the telescope and having
a median segment;
two opposite recesses defined in the mediate portion in parallel; and
two pairs of threaded bracket-adjusting holes defined in the median segment and in the recesses, respectively;
a movable bracket rotatably and slidably mounted on the stationary bracket, attached to the casing and having
a bottom;
a top;
two sides;
a bracket recess defined in the bottom of the movable bracket and rotatably and slidably holding the stationary bracket;
a pivot ridge formed on the top of the movable bracket and abutting the bottom of the casing;
four casing-adjusting holes defined vertically through the movable bracket at intervals; and
two pairs of bracket-adjusting holes defined respectively in the sides of the movable bracket;
two pairs of bracket-adjusting bolts respectively extending through the pairs of the bracket-adjusting holes in the sides of the movable bracket and respectively screwing in the pairs of threaded bracket-adjusting holes in the stationary bracket; and
four casing-adjusting bolts extending through the casing-adjusting holes in the movable bracket and screwing into the threaded casing-adjusting holes in the bottom of the casing; and
multiple pushbuttons and a display mounted to the body and connected to the laser indicator.

2. The theodolite as claimed in claim 1, wherein:
the casing further has multiple threaded generator-adjusting holes defined in the casing and communicating with the cavity; and
the laser generator further has
an outer surface;
multiple notches defined circularly in the outer surface; and
multiple generator-adjusting bolts mounted respectively through the threaded generator-adjusting holes in the casing and respectively engage the notches in the laser generator.

3. The theodolite as claimed in claim 1, wherein the prism of laser indicator is a pentagonal prism.

4. The theodolite as claimed in claim 2, wherein the prism of laser indicator is a pentagonal prism.
